(19) United States
(12) Patent Application Publication
(10) Pub. No.: US 2009/0213242 A1
(43) Pub. Date: Aug. 27, 2009

(54) IMAGE CAPTURE MODULE AND APPLICATIONS THEREOF

(75) Inventors: AHMADREZA (REZA) ROFOUGARAN, NEWPORT COAST, CA (US); TIMOTHY W. MARKISON, LAHAINA, HI (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/431,524

(22) Filed: Apr. 28, 2009

Related U.S. Application Data
(63) Continuation-in-part of application No. 12/026,681, filed on Feb. 6, 2008.

(51) Int. Cl. H04N 5/228; H04N 5/225; H04N 5/232

(52) U.S. Cl. 348/222.1; 348/340; 348/345; 348/E05.024; 348/E05.091; 348/E05.045

(57) ABSTRACT

An image capture module includes a user interface module, an optical system module, and a coupling module. The user interface module is operably coupled to detect a request to capture an image and generate a capture command signal in response to detecting the request. The optical system module is operably coupled to receive light representing the image from a lens in accordance with the capture command signal. The optical system module then accumulates a plurality of electric charges, wherein an electric charge of the plurality of electric charges is proportional to intensity of a corresponding portion of the light. The optical system module then generates a sequence of voltages from the plurality of electric charges. The coupling module is operably coupled to convert a representation of the sequence of voltages into a transmission signal and to transmit the transmission signal.

This patent application is claiming priority under 35 USC § 120 as a continuation in part patent application of co-pending patent application entitled COMPUTING DEVICE WITH HANDHELD AND EXTENDED COMPUTING UNITS, having a filing date of Feb. 6, 2008.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to communication systems and more particularly to computing devices used in such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless or wired networks. The wireless and/or wire lined communication devices may be personal computers, laptop computers, personal digital assistants (PDA), cellular telephones, personal digital video players, personal digital audio players, global positioning system (GPS) receivers, video game consoles, entertainment devices, etc.

Many of the communication devices include a similar basic architecture: that being a processing core, memory, and peripheral devices. In general, the memory stores operating instructions that the processing core uses to generate data, which may also be stored in the memory. The peripheral devices allow a user of the communication device to direct the processing core as to which operating instructions to execute, to enter data, etc. and to see the resulting data. For example, a personal computer includes a keyboard, a mouse, and a display, which a user uses to cause the processing core to execute one or more of a plurality of applications.

While the various communication devices have a similar basic architecture, they each have their own processing core, memory, and peripheral devices and provide distinctly different functions. For example, a cellular telephone is designed to provide wireless voice and/or data communications in accordance with one or more wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof). As another example, a personal digital audio player is designed to decompress a stored digital audio file and render the decompressed digital audio file audible.

Over the past few years, integration of the some of the communication device functions into a single device has occurred. For example, many cellular telephones now offer personal digital audio playback functions, PDA functions, and/or GPS receiver functions. Typically, to load one or more of these functions, files, or other applications onto a handheld communication device (e.g., a cellular telephone, a personal digital audio and/or video player, a PDA, a GPS receiver), the handheld communication device needs to be coupled to a personal computer or laptop computer. In this instance, the desired application, function, and/or file is first loaded on to the computer and then copied to the handheld communication device; resulting in two copies of the application, function, and/or file.

To facilitate such loading of the application, function, and/or file in this manner, the handheld communication device and the computer each require hardware and corresponding software to transfer the application, function, and/or file from the computer to the handheld communication device. As such, two copies of the corresponding software exist as well as having two hardware components (one for the handheld device and the second for the computer). In addition to the redundancy of software, timing issues, different versions of the software, incompatible hardware, and a plethora of other reasons cause the transfer of the application, function, and/or file to fail.

In addition to integration of some functions into a single handheld device, handheld digital audio players may be docked into a speaker system to provide audible signals via the speakers as opposed to a headphone. Similarly, a laptop computer may be docked to provide connection to a full size keyboard, a separate monitor, a printer, and a mouse. In each of these docking systems, the core architecture is not changed.

While integration of functions into a single handheld device have enabled such devices to perform multiple functions (e.g., play digital music, take digital photographs, take digital movies, display digital images, etc.), there are physical limitations as to what can be integrated. For instance, many cell phones include a digital camera function that enables the user to capture still or moving digital images. However, due to the physical size of the cell phone, the lens that can be included in the cell phone is limited in size. Such a limit in size of the lens, limits the optical capabilities (e.g., zoom, aperture, focal length, resolution, aberrations reduction, etc.) of the digital camera function.

As such, to achieve a desired level of digital photography, higher end digital cameras such SLR (single lens reflex) cameras, bridge cameras, Digital SLR cameras, etc. are used. The higher end cameras have a similar basic architecture to that of a PC, a laptop computer, a cell phone, and other handheld devices. Thus, a user who wants higher quality digital photographs than available from a cell phone and wants to have cell phone access must carry two devices, each having the same basic core architecture. For the two devices to communicate, the above issues must be addressed.

Therefore, a need exists for a device that has a single core architecture and includes an image capture module that may be coupled to a handheld computing device.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a diagram of an embodiment of a computing device that includes a handheld computing unit and an extended computing unit in accordance with the present invention;

FIG. 2 is a diagram of an embodiment of a handheld computing unit docked to an extended computing unit within a communication system in accordance with the present invention;

FIG. 3 is a diagram of an embodiment of a handheld computing unit quasi-docked to an extended computing unit within a communication system in accordance with the present invention;

FIG. 4 is a diagram of an embodiment of a handheld computing unit coupled to an image capture module in a remote mode with respect to an extended computing unit within a communication system in accordance with the present invention;

FIG. 5 is a schematic block diagram of an embodiment of a handheld computing unit and of an image capture module in accordance with the present invention;

FIG. 6 is a schematic block diagram of another embodiment of a handheld computing unit and of an image capture module in accordance with the present invention;

FIG. 7 is a schematic block diagram of another embodiment of a handheld computing unit and of an image capture module in accordance with the present invention; and

FIG. 8 is a schematic block diagram of another embodiment of a handheld computing unit and of an image capture module in accordance with the present invention.

### DETAILED DESCRIPTION OF THE INVENTION

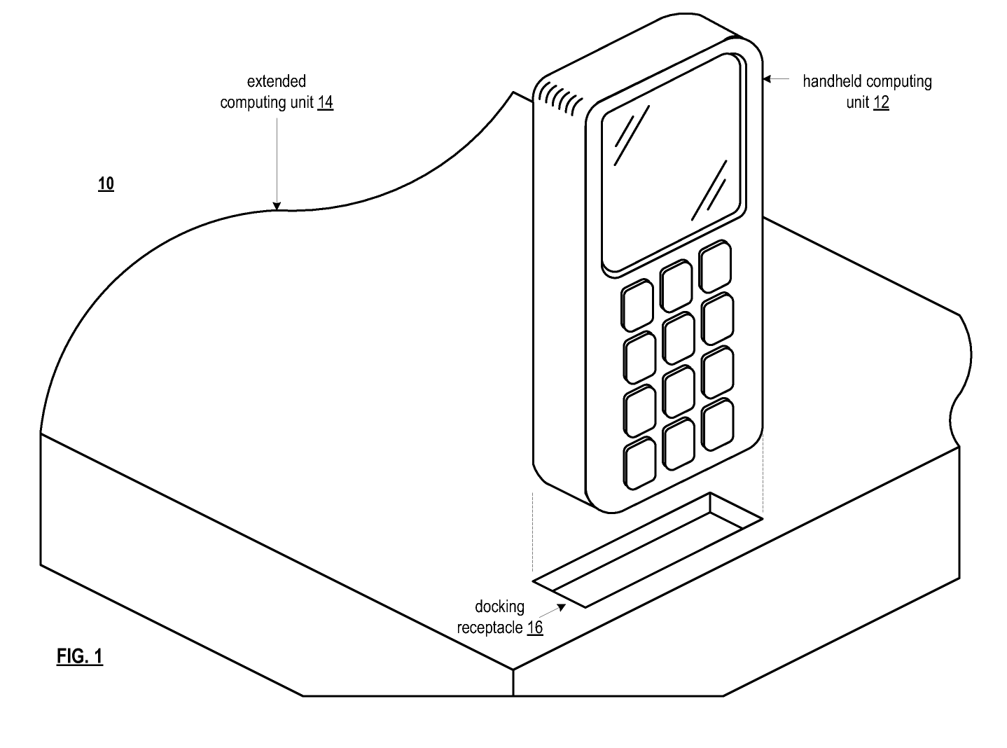

FIG. 1 is a diagram of an embodiment of a computing device 10 that includes a handheld computing unit 12 and an extended computing unit 14. The handheld computing unit 12 may have a form factor similar to a cellular telephone, personal digital assistant, personal digital audio/video player, etc. and includes a connector structure that couples to a docketing receptacle 16 of the extended computing unit 14.

In general, the handheld computing unit 12 includes the primary processing module (e.g., central processing unit), the primary main memory, and the primary hard disk memory for the computing device 10. In this manner, the handheld computing unit 12 functions as the core of a personal computer (PC) or laptop computer when it is docked to the extended computing unit and functions as a cellular telephone, a GPS receiver, a personal digital audio player, a personal digital video player, a personal digital assistant, and/or other handheld electronic device when it is not docked to the extended computing unit.

In addition, when the handheld computing unit 12 is docked to the extended computing unit 14, files and/or applications can be swapped therebetween. For example, assume that the user of the computing device 10 has created a presentation using presentation software and both reside in memory of the extended computing unit 14. The user may elect to transfer the presentation file and the presentation software to memory of the handheld computing unit 12. If the handheld computing unit 12 has sufficient memory to store the presentation file and application, then it is copied from the extended computing unit memory to the handheld computing unit memory. If there is not sufficient memory in the handheld computing unit, the user may transfer an application and/or file from the handheld computing unit memory to the extended computing unit memory to make room for the presentation file and application.

With the handheld computing unit 12 including the primary components for the computing device 10, there is only one copy of an application and/or of a file to support PC functionality, laptop functionality, and a plurality of handheld device functionality (e.g., TV, digital audio/video player, cell phone, PDA, GPS receiver, etc.). In addition, since only one copy of an application and/or of a file exists (other than desired backups), special software to transfer the applications and/or files from a PC to a handheld device is no longer needed. As such, the processing module, main memory, and I/O interfaces of the handheld computing unit 12 provide a single core architecture for a PC and/or a laptop, a cellular telephone, a PDA, a GPS receiver, a personal digital audio player, a personal digital video player, etc.

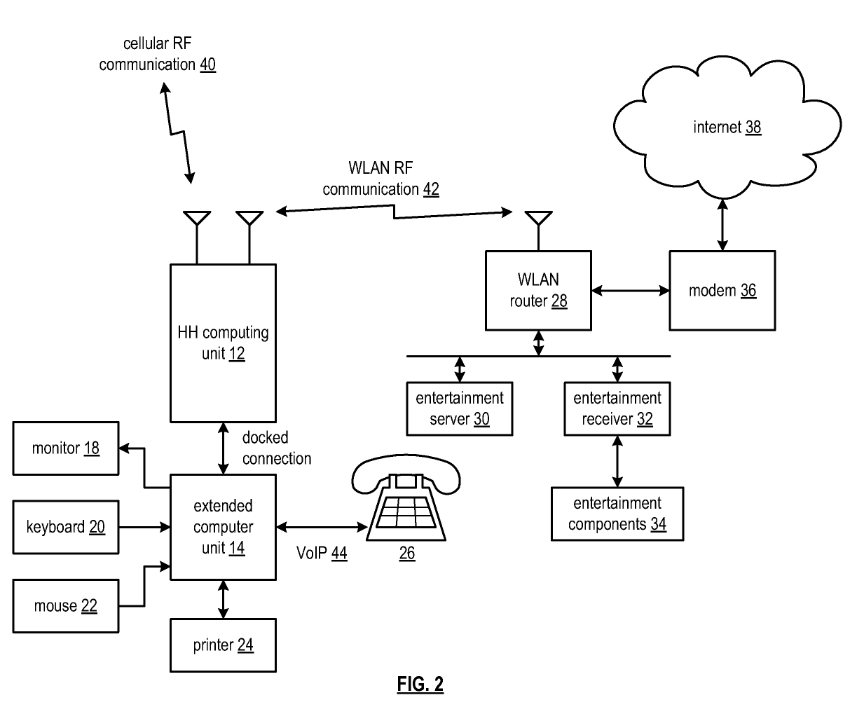

FIG. 2 is a schematic block diagram of an embodiment of a handheld computing unit 12 docked to an extended computing unit 14 within a communication system. In this embodiment, the communication system may include one or more of a wireless local area network (WLAN) router 28, a modem 36 coupled to the internet 38, an entertainment server 30 (e.g., a server coupled to database of movies, music, video games, etc.), an entertainment receiver 32, entertainment components 34 (e.g., speaker system, television monitor and/or projector, DVD (digital video disc) player or newer versions thereof, VCR (video cassette recorder), satellite set top box, cable set top box, video game console, etc.), and a voice over internet protocol (VoIP) phone 26. As an alternative or in addition to the WLAN router 28, the system may include a local area network (LAN) router coupled to the extended computing unit 14.

As is also shown, the extended computing unit 14 is coupled to a monitor 18, a keyboard, a mouse 22, and a printer 24. The extended computing unit 14 may also be coupled to other devices (not shown) such as a trackball, touch screen, gaming devices (e.g., joystick, game pad, game controller, etc.), an image scanner, a webcam, a microphone, speakers, and/or a headset. In addition, the extended computing unit 14 may have a form factor similar to a personal computer and/or a laptop computer. For example, for in-home or in-office use, having the extended computing unit with a form factor similar to a PC may be desirable. As another example, for traveling users, it may be more desirable to have a laptop form factor.

In this example, the handheld computing unit 12 is docked to the extended computer unit 14 and function together to provide the computing device 10. The docking of the handheld computing unit 12 to the extended computing unit 14 encompasses one or more high speed connections between the units 12 and 14. Such a high speed connection may be provided by an electrical connector, by an RF connector (an example is discussed with reference to FIG. 45 of the parent patent application), by an electromagnetic connector (an example is discussed with reference to FIG. 46 of the parent patent application), and/or a combination thereof. In this mode, the handheld computing unit 12 and the extended computing 14 collectively function similarly to a personal computer and/or laptop computer with a WLAN card and a cellular telephone card.

In this mode, the handheld computing unit 12 may transceive cellular RF communications 40 (e.g., voice and/or data communications). Outgoing voice signals may originate at the VoIP phone 26 as part of a VoIP communication 44 or a microphone coupled to the extended computing unit 14. The outgoing voice signals are converted into digital signals that are subsequently converted to outbound RF signals. Inbound RF signals are converted into incoming digital audio signals and that may be provided to a sound card within the extended computing unit for presentation on speakers or provided to the VoIP phone via as part of a VoIP communication 44.

Outgoing data signals may originate at the mouse 22, keyboard 20, image scanner, etc. coupled to the extended computing unit 14. The outgoing data signals are converted into digital signals that are subsequently converted to outbound RF signals. Inbound RF signals are converted into incoming data signals and that may be provided to the monitor 18, the printer 24, and/or other character presentation device.

In addition, the handheld computing unit 12 may provide a WLAN transceiver for coupling to the WLAN router 28 to support WLAN RF communications 42 for the computing device 10. The WLAN communications 42 may be for accessing the internet 38 via modem 36, for accessing the entertainment server, and/or accessing the entertainment receiver 32. For example, the WLAN communications 42 may be used to support surfing the web, receiving emails, transmitting emails, accessing on-line accounts, accessing on-line games, accessing on-line user files (e.g., databases, backup files, etc.), downloading music files, downloading video files, downloading software, etc. As another example, the computing device 10 (i.e., the handheld computing unit 12 and the extended computing unit 14) may use the WLAN communications 42 to retrieve and/or store music and/or video files on the entertainment server; and/or to access one or more of the entertainment components 34 and/or the entertainment receiver 32.

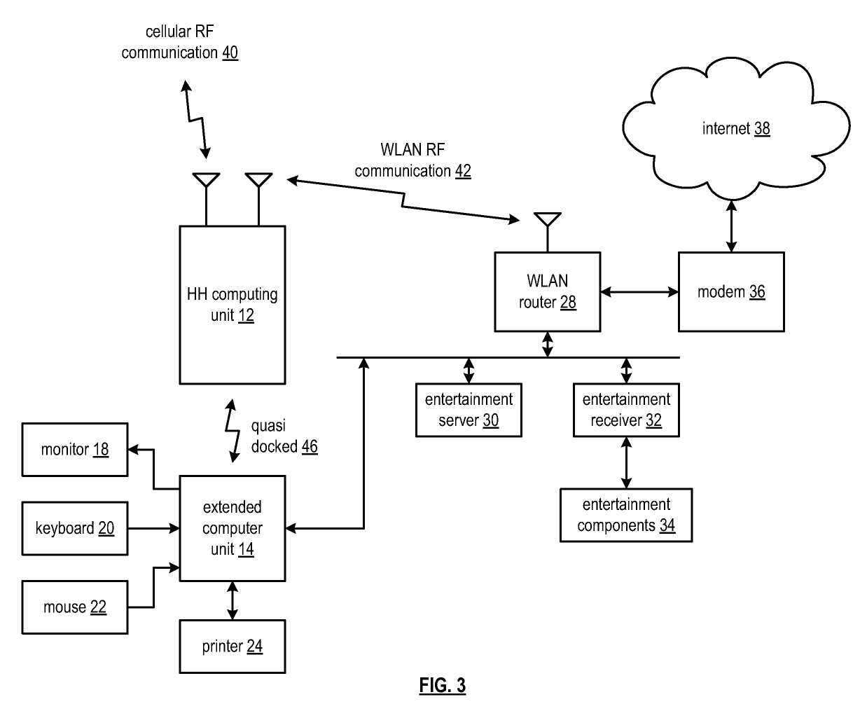

FIG. 3 is a schematic block diagram of an embodiment of a handheld computing unit 12 quasi docked to an extended computing unit 14 within a communication system. In this embodiment, the communication system may include one or more of a wireless local area network (WLAN) router 28, a modem 36 coupled to the internet 38, an entertainment server 30 (e.g., a server coupled to database of movies, music, video games, etc.), an entertainment receiver 32, entertainment components 34 (e.g., speaker system, television monitor and/or projector, DVD (digital video disc) player or newer versions thereof, VCR (video cassette recorder), satellite set top box, cable set top box, video game console, etc.), and a voice over internet protocol (VoIP) phone 26. As an alternative or in addition to the WLAN router 28, the system may include a local area network (LAN) router coupled to the extended computing unit 14.

As is also shown, the extended computing unit 14 is coupled to a monitor 18, a keyboard, a mouse 22, and a printer 24. The extended computing unit 14 may also be coupled to other devices (not shown) such as a trackball, touch screen, gaming devices (e.g., joystick, game pad, game controller, etc.), an image scanner, a webcam, a microphone, speakers, and/or a headset. In addition, the extended computing unit 14 may have a form factor similar to a personal computer and/or a laptop computer.

In this example, the handheld computing unit 12 is quasi docked 46 to the extended computer unit 14, where the handheld computing unit 12 functions as a stand-alone computer with limited resources (e.g., processing modules, user inputs/outputs, main memory, etc. of the handheld computing unit) and limited access to the memory of the extended computing unit 14. The quasi docking 46 of the handheld computing unit 12 to the extended computing unit 14 is provided by an RF communication, where an RF transceiver of the handheld computing unit 12 is communicating with an RF transceiver of the extended computing unit 14. Depending on the bit rate of the RF connection, the handheld computing unit can access files and/or applications stored in memory of the extended computing unit 14. In addition, the handheld computing unit 12 may direct the processing module of the extended computing unit 14 to perform a remote co-processing function, but the processing module of the handheld computing unit and the extended computing unit do not function as a multiprocessing module as they do when in the docked mode.

As an alternative, the quasi docked mode may be achieved by the handheld computing unit 12 communicating with the extended computing unit via the WLAN communication 42 and the WLAN router 28. As yet another example, the quasi docked mode may be achieved via a data cellular RF communication 40 via the internet 38 to the extended computing unit 14.

In this mode, the handheld computing unit 12 may transceive cellular RF communications 40 (e.g., voice and/or data communications). Outgoing voice signals originate at a microphone of the handheld computing unit 12. The outgoing voice signals are converted into digital signals that are subsequently converted to outbound RF signals. Inbound RF signals are converted into incoming digital audio signals and that are provided to a speaker, or headphone jack, of the handheld computing unit 12.

Outgoing data signals originate at a keypad or touch screen of the handheld computing unit 12. The outgoing data signals are converted into digital signals that are subsequently converted to outbound RF signals. Inbound RF signals are converted into incoming data signals that are provided to the handheld display and/or other handheld character presentation device.

In addition, the handheld computing unit 12 may provide a WLAN transceiver for coupling to the WLAN router 28 to support WLAN RF communications 42 with the WLAN router 28. The WLAN communications 42 may be for accessing the internet 38 via modem 36, for accessing the entertainment server, and/or accessing the entertainment receiver 32. For example, the WLAN communications 42 may be used to support surfing the web, receiving emails, transmitting emails, accessing on-line accounts, accessing on-line games, accessing on-line user files (e.g., databases, backup files, etc.), downloading music files, downloading video files, downloading software, etc. As another example, the handheld computing unit 12 may use the WLAN communications 42 to retrieve and/or store music and/or video files on the entertainment server; and/or to access one or more of the entertainment components 34 and/or the entertainment receiver 32.

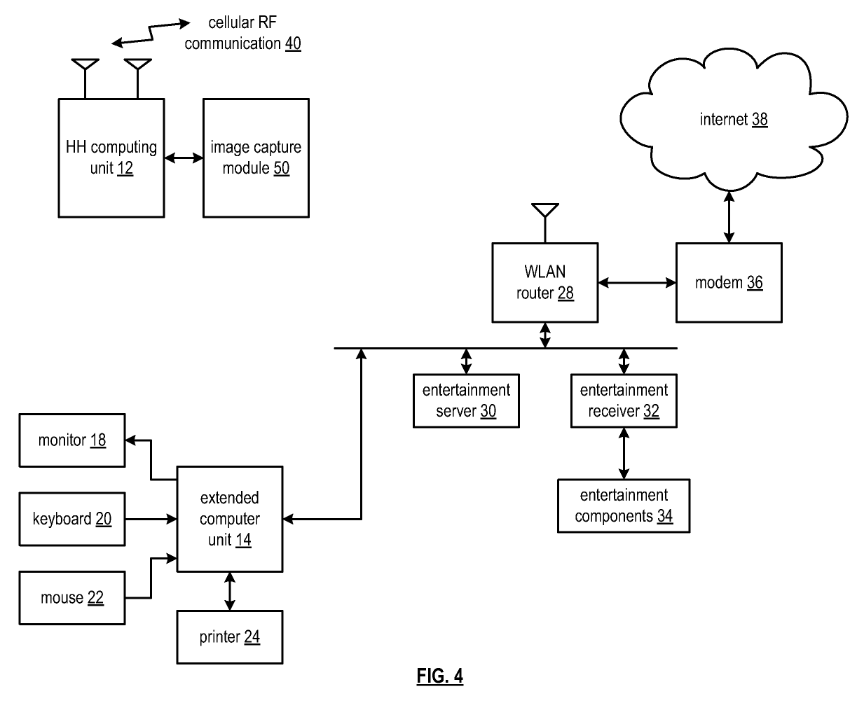

FIG. 4 is a schematic block diagram of an embodiment of a handheld (HH) computing unit 12 in a remote mode with respect to an extended computing unit 14. In this mode, the handheld computing unit 12 has no communications with the extended computing unit 14. As such, the extended computing unit 14 is disabled and the handheld computing unit 12 functions as a stand-alone computing device.

In the stand-alone mode, the HH computing unit 12 may be coupled to an image capture module 50 for high quality digital photography. In this configuration, the HH unit 12 includes the core processing and memory for a digital camera function and the image capture module 50 provides a high end lens, lens mount, and circuitry to receive light and convert it into stored electronic charges. The image capture module 50 may have a form factor similar to higher quality DSLR, SLR, and/or bridge cameras. In this manner, a user who wants high quality digital photographs and wants to have cell phone access can achieve both with a single basic core architecture of the device that includes HH unit 12 coupled to the image capture module 50. This single basic core architecture of the device substantially eliminates the communication issues, required software, and hardware needed for two separate devices to share data.

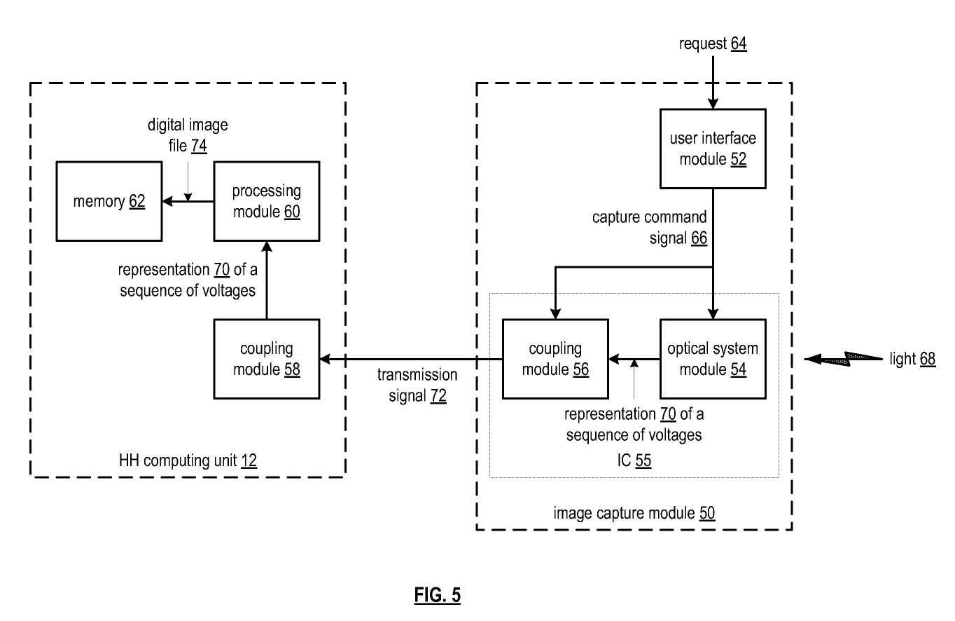

FIG. 5 is a schematic block diagram of an embodiment of a device that includes the handheld (HH) computing unit 12 and the image capture module 50. The image capture module 50 includes a user interface module 52, an optical system 54, and a coupling module 56. The HH computing unit 12 includes a coupling module 58, a processing module 60, and memory 62. While not shown, the image capture module 56 may further include a pop-up or fixed flash, a digital range finder, etc.

In an example of operation, the user interface module 52 detects a request 64 to capture an image. The request 64 may be to capture a still image (e.g., a picture), a moving image (e.g., a movie), and/or a sound image (e.g., an audio or voice recording). The request 64 may also include mode selection information indicating how the image is to be captured. For example, the mode selection information may include an exposure setting, an aperture setting, a focus setting (e.g., close up, mid range, far range, human faces, etc.), a light metering setting (e.g., to determine proper exposure), a white balance setting (e.g., an adjustment of the intensities of the primary colors), and/or an equivalent sensitivity setting. Accordingly, an embodiment of the user interface module 52 includes circuitry to detect selection (e.g., pressing of mechanical buttons, switches, touches on a touch screen, etc.) of the request and corresponding parameters.

After detecting the request 64, the user interface module 52 generates a capture command signal 66 and provides it to the optical system module 54 and may also provide it to the coupling module 56. The capture command signal 66 includes the details of the request 64 (e.g., capture a picture, a movie, audio, and mode selection information, if any). Note that, if the request 64 includes a component to capture a sound image as an audio recording or as part of capturing a moving image, the user interface module 52 provides the signal 66, or at least the sound recording portion, to the coupling module 56. The coupling module 56, using a coupling protocol, provides the signal 66 to the HH computing unit 12, which performs the audio recording.

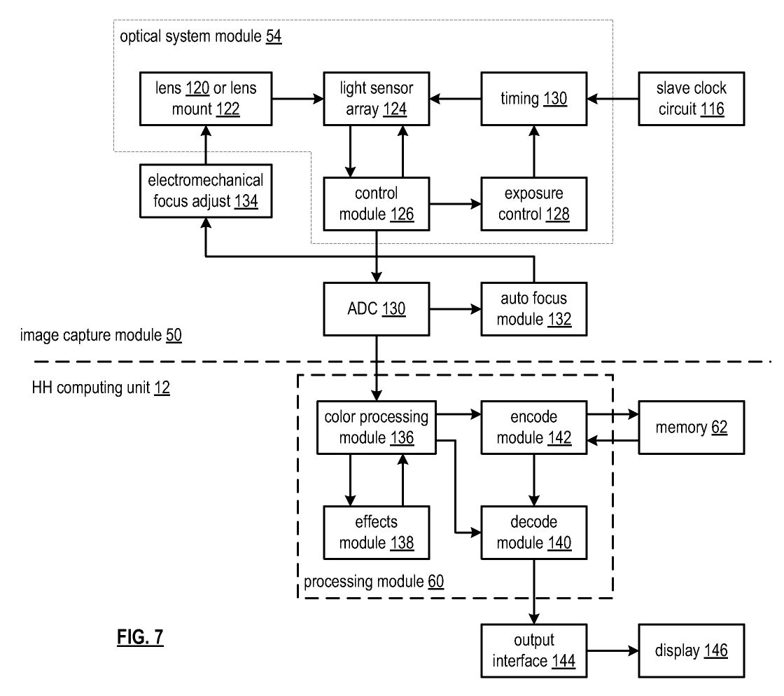

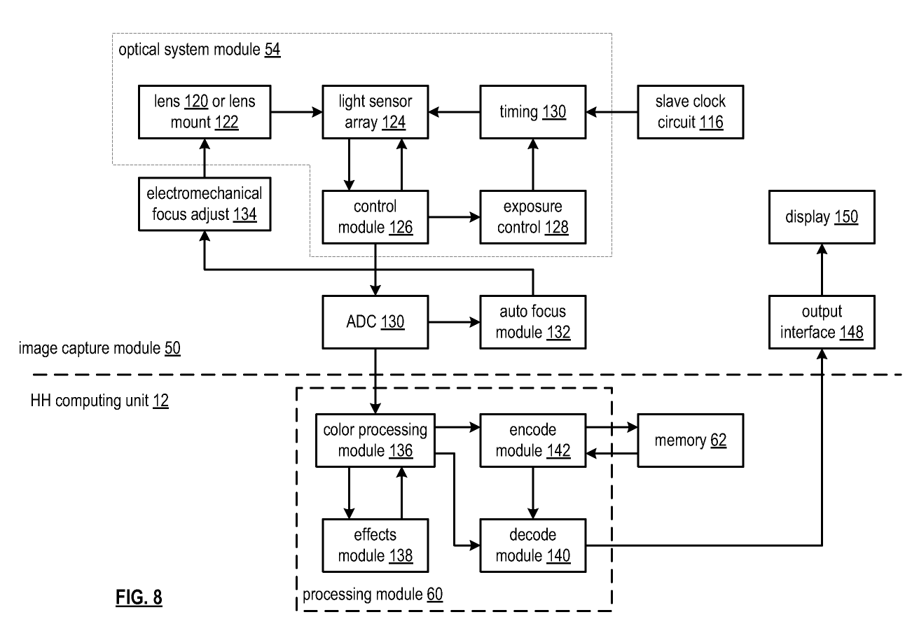

The optical system module 54 (embodiments of which will be described in greater detail with reference to FIGS. 7 and 8) receives the capture command signal 66 and in response thereto receives light representing the image from a lens. As the light is being received in accordance with the capture command signal 66 (e.g., exposure setting, aperture setting, etc.), the optical system module 54 accumulates a plurality of electric charges. The electric charges are proportional to the intensity of the light, which represents the image. As such, an electric charge has a corresponding portion of the light that represents a corresponding portion of the image. The optical system module 54 then generates a sequence of voltages from the plurality of electric charges.

The optical system module 54 provides a representation 70 of the sequence of voltages to the coupling module 56. The representation 70 of the sequence of voltages may be the sequences of voltage themselves (e.g., an analog signal). Alternatively, the representation 70 may be a digital conversion of the analog voltages into a stream of digital data. As another alternative or in furtherance of the previous examples, the representation 70 may be a signal transformation of the sequence of voltages (e.g., level shift, buffering, driving, etc.) As a further alternative or in furtherance of the previous examples, the representation 70 may be a compression or interpretation of the sequence of voltages or of the stream of digital data.

The coupling module 56 converts the representation 70 of the sequence of voltages into a transmission signal 72. The conversion of the representation 70 into the transmission signal 72 depends on whether the coupling between the image capture module 50 and the HH computing module 12 is wired or wireless. For wired coupling, the coupling module 56 may include a connector and a driver to support a particular wired interface (e.g., Universal serial bus, peripheral component interconnect, Firewire, serial port communication, parallel port communication, etc.). For wireless coupling, the coupling module may include a wireless transceiver operable in one or more of a plurality of frequency bands (e.g., 2.4 GHz, 5 GHz, 29 GHz, 60 GHz, etc.) and functions in accordance with one or more wireless communication protocols (e.g., Bluetooth, ZigBee, IEEE802.11, etc.). Having converting the representation 70 of the sequence of voltages into the transmission signal 72, the coupling module 58 transmits it to the HH computing unit 12.

The coupling module 58 of the HH computing unit 12 receives the transmission signal 72 and recovers, therefrom, the representation 70 of the sequence of voltages. The coupling module provides the representation 70 to the processing module 60. Note that if the request 64 included a request to capture a sound image, the coupling module 56 provides a representation of the capture command signal 66 to the coupling module 58 of the HH computing unit 12. The coupling module 58 recovers the capture command signal 66, or relevant audio portion thereof, and provides it to the processing module 60.

The processing module 60 converts the representation 70 of the sequence of voltages into a digital image file 74 in accordance with a file format protocol (e.g., Lossless Raw Data Format, JPEG, TIFF for pictures; AVI, DV, MPEG, MOV, WMV, ASF, MP4 for video; and MP3, MP4, WMA for audio). The processing module 60 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 60 may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 60 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module 60 executes, hard coded and/or operational instructions corresponding to at least some of the steps and/or functions illustrated in FIGS. 1-8.

The memory 62 stores the digital image file 74. The memory 62 may be the main memory of the HH computing 12, flash memory of the HH computing unit, a hard drive of the HH computing unit 12, and/or other digital storage medium of the HH computing unit 12. Note that the digital image file 74 may further include metadata regarding the image. For instance, the metadata may include the exposure setting, the aperture setting, light metering, etc.

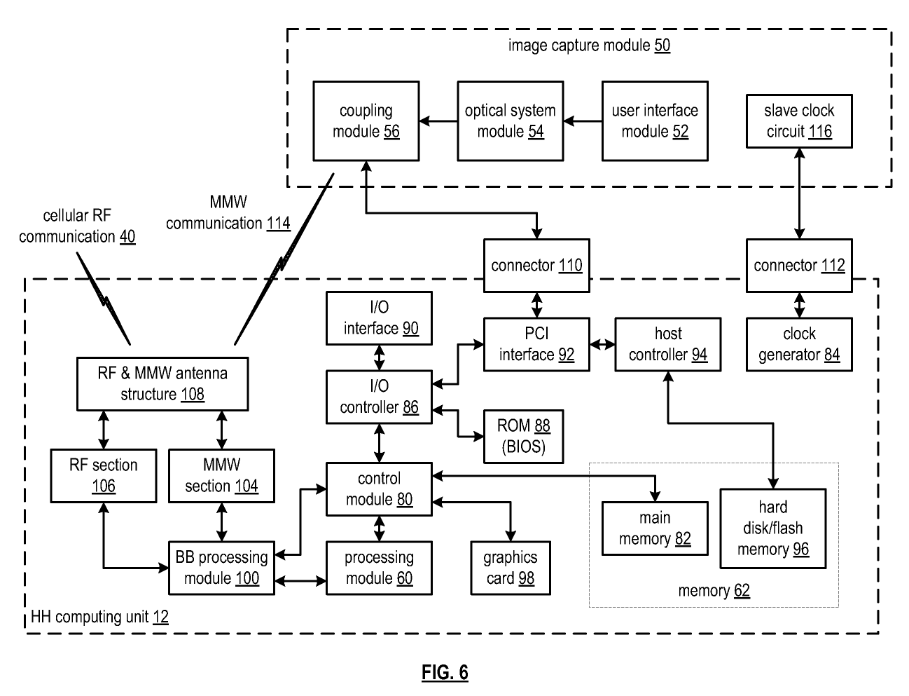

FIG. 6 is a schematic block diagram of another embodiment of a device that includes the handheld (HH) computing unit 12 and the image capture module 50. In this embodiment, the image capture module 50 includes the user interface module 52, the optical system module 54, the coupling module 56, and a slave clock circuit 116. The HH computing unit 12 includes the processing module 60, a control module 80, main memory 82, a hard disk drive and/or flash memory 96, a clock generator 84, an input/output (IO) controller 86, a read only memory (ROM) Basic Input Output System (BIOS) 88, an IO interface 90, a PCI interface 92, a host controller 94, a graphics card and/or graphics engine 98, a baseband (BB) processing module 100, a millimeter wave (MMW) section 104, and radio frequency (RF) section 106, an RF & MMW antenna structure 108, and connectors 110 & 112.

Within the handheld computing unit 12, the handheld hard disk/flash memory 96 may be one or more of a hard disk, a floppy disk, an optical disk, NOR flash memory, NAND flash memory, and/or any other type of non-volatile memory. The clock generator circuit 84 may be one or more of: a phase locked loop, a crystal oscillator circuit, a fractional-N synthesizer, and/or a resonator circuit-amplifier circuit, where the resonator may be a quartz piezo-electric oscillator, a tank circuit, or a resistor-capacitor circuit. Regardless of the implementation of the clock generator circuit 84, it generates a master clock signal that is provided to the slave clock circuit 106 via a wired or wireless connector 112 and generates the clock signals for the handheld computing unit 12. Such clock signals include, but are not limited to, a bus clock, a read/write clock, a processing module clock, a local oscillation, and an I/O clock.

The handheld ROM 88 stores the basic input/output system (BIOS) program for the computing device 10 (i.e., the handheld computing unit 12 coupled to the extended computing unit 14) and for a stand-alone mode (which may include coupling to the image capture module 50). The ROM 88 may be one or more of an electronically erasable programmable ROM (EEPROM), a programmable ROM (PROM), and/or a flash ROM.

As used herein, an interface includes hardware and/or software for a device coupled thereto to access the bus of the handheld computing unit and/or of the extended computing unit. For example, the interface software may include a driver associated with the device and the hardware may include a signal conversion circuit, a level shifter, etc. Within the handheld computing unit, the I/O interface 90 may include an audio codec, a volume control circuit, a microphone bias circuit, and/or an amplifier circuit coupled to a handheld (HH) microphone and/or to HH speakers. The I/O interface 90 may further include a video codec, a graphics engine, a display driver, etc. coupled to an HH display. The I/O interface 90 may also include a display driver, a keypad driver, a touch screen driver, etc. coupled to the HH display and/or the HH keypad.

The control module 80 functions as a memory controller to coordinate the reading data from and writing data to the HH main memory 82 and the EXT main memory 96 (e.g., memory 62), by the processing module 60, by the user I/O devices coupled directly or indirectly to the I/O controller 86, and/or by the graphics card and/or graphics engine 98. Note that if the HH main memory 52 includes DRAM, the control module 58 includes logic circuitry to refresh the DRAM.

I/O controller 86 provides access to the control module 80 for typically slower devices. For example, the I/O controller 86 provides functionality for the PCI bus via the PCI interface 92; for the I/O interface 90, which may provide the interface for the keyboard, mouse, printer, and/or a removable CD/DVD disk drive; for a direct memory access (DMA) controller; for interrupt controllers; an/or for a host controller 94, which allows direct access to the hard disk drive and/or flash memory 96; a real time clock, and/or an audio interface. The I/O controller 86 may also include support for an Ethernet network card, a Redundant Arrays of Inexpensive Disks (RAID), a USB interface, and/or FireWire.

The graphics card and/or graphics engine 98 may include a graphics processing unit (GPU) that is a dedicated graphics rendering device for manipulating and displaying computer graphics. In general, the GPU implements a number of graphics primitive operations and computations for rendering two-dimensional and/or three-dimensional computer graphics. Such computations may include texture mapping, rendering polygons, translating vertices, programmable shaders, aliasing, and very high-precision color spaces. The graphics card and/or graphics engine 98 may further include functionality to support video capture, TV tuner adapter, MPEG-2 and MPEG-4 decoding or FireWire, mouse, light pen, joystick connectors, and/or connection to two monitors.

In an example of operation, the HH computing unit 12 is active to support a cellular telephone. In this state, the processing module 60, the baseband processing module 100 and the RF section 118 are active. For example, the baseband processing module 100 receives an outbound voice signal from the control module 80 or from the processing module 60. The control module 80 may receive the outbound voice signal from the HH IO controller 86 that is coupled to a microphone input, or may retrieve a stored outbound voice signal (e.g., an outgoing message) from memory 62. The processing module 60 may receive the outbound voice signal from the control module 80 and further process the signal (e.g., combine it with another signal, perform higher level OSI functions beyond the PHY layer processing, etc.) and provide the processed signal to the BB processing module 54 as the outbound voice signal.

The baseband processing module 100 converts an outbound voice signal into an outbound voice symbol stream in accordance with one or more existing wireless communication standards, new wireless communication standards, modifications thereof, and/or extensions thereof (e.g., GSM, AMPS, digital AMPS, CDMA, WCDMA, LTE, WiMAX, etc.). The baseband processing module 54 may perform one or more of scrambling, encoding, constellation mapping, modulation, frequency spreading, frequency hopping, beamforming, space-time-block encoding, space-frequency-block encoding, and/or digital baseband to IF conversion to convert the outbound voice signal into the outbound voice symbol stream. Depending on the desired formatting of the outbound voice symbol stream, the baseband processing module 100 may generate the outbound voice symbol stream as Cartesian coordinates (e.g., having an in-phase signal component and a quadrature signal component to represent a symbol), as Polar coordinates (e.g., having a phase component and an amplitude component to represent a symbol), or as hybrid coordinates as disclosed in co-pending patent application entitled HYBRID RADIO FREQUENCY TRANSMITTER, having a filing date of Mar. 24, 2006, and an application number of Ser. No. 11/388,822, and co-pending patent application entitled PROGRAMMABLE HYBRID TRANSMITTER, having a filing date of Jul. 26, 2006, and an application number of Ser. No. 11/494,682.

The RF section 106 converts the outbound voice symbol stream into an outbound RF voice signal in accordance with the one or more existing wireless communication standards, new wireless communication standards, modifications thereof, and/or extensions thereof (e.g., GSM, AMPS, digital AMPS, CDMA, WCDMA, LTE, WiMAX, etc.). In one embodiment, the RF section 106 receives the outbound voice symbol stream as Cartesian coordinates. In this embodiment, the RF section 106 mixes the in-phase components of the outbound voice symbol stream with an in-phase local oscillation to produce a first mixed signal and mixes the quadrature components of the outbound voice symbol stream to produce a second mixed signal. The RF section 106 combines the first and second mixed signals to produce an up-converted voice signal. The RF section 106 then amplifies the up-converted voice signal to produce the outbound RF voice signal, which it provides to an antenna section 108. Note that further power amplification may occur between the output of the RF section 106 and the input of the antenna structure 108.

In one or more other embodiments, the RF section 106 receives the outbound voice symbol stream as Polar or hybrid coordinates. In these embodiments, the RF section 106 modulates a local oscillator based on phase information of the outbound voice symbol stream to produce a phase modulated RF signal. The RF section 106 then amplifies the phase modulated RF signal in accordance with amplitude information of the outbound voice symbol stream to produce the outbound RF voice signal. Alternatively, the RF section 106 may amplify the phase modulated RF signal in accordance with a power level setting to produce the outbound RF voice signal.

The RF section 106 provides the outbound RF voice signal to the antenna structure 108, which includes the plurality of inductors (L) and a plurality of antenna segments (T). In an embodiment, the inductors (L) have an inductance that provides a low impedance at the carrier frequency of the outbound RF voice signal (e.g., 900 MHz, 1800 MHz, 1900 MHz, etc.) and provides a high impedance at the carrier frequency of a MMW signal (e.g., 60 GHz). For example, 17.9 nano-Henries provides an impedance of approximately 1 Ohm at 900 MHz and provides an impedance of approximately 6.75 K-Ohm at 60 GHz.

Each antenna segment (T), which may be a metal trace on a printed circuit board and/or on an integrated circuit, has a length corresponding to ¼ wavelength, ½ wavelength, or other numerical relationship to the wavelength of the MMW signal. For example, if the MMW signal has a carrier frequency of 60 GHz, then a length of an antenna segment would be 0.25 millimeters for a ½ wavelength segment and 0.125 for a quarter wavelength segment. The total number of segments (T) used for transmitting the outbound RF voice signal depends on the carrier frequency of the RF signal to achieve the desired length of the antenna. In this example, the resulting RF antenna is shown as a meandering trace that includes a plurality of segments (T) coupled via a plurality of inductors (L), but other antenna shapes may be used.

For incoming voice signals, the RF section 106 receives an inbound RF voice signal via the antenna section 108. The RF section 106 converts the inbound RF voice signal into an inbound voice symbol stream. In an embodiment, the RF section 106 extracts Cartesian coordinates from the inbound RF voice signal to produce the inbound voice symbol stream. In another embodiment, the RF section 106 extracts Polar coordinates from the inbound RF voice signal to produce the inbound voice symbol stream. In yet another embodiment, the RF section 106 extracts hybrid coordinates from the inbound RF voice signal to produce the inbound voice symbol stream.

The baseband processing module 100 converts the inbound voice symbol stream into an inbound voice signal. The baseband processing module 100 may perform one or more of descrambling, decoding, constellation demapping, modulation, frequency spreading decoding, frequency hopping decoding, beamforming decoding, space-time-block decoding, space-frequency-block decoding, and/or IF to digital baseband conversion to convert the inbound voice symbol stream into the inbound voice signal.

The baseband processing module 100 and the RF section 106 function similarly for transceiving data communications (e.g., GPRS, EDGE, HSUPA, HSDPA, etc.) and for processing WLAN communications. For data communications, the baseband processing module 100 and the RF section 106 function in accordance with one or more cellular data protocols such as, but not limited to, Enhanced Data rates for GSM Evolution (EDGE), General Packet Radio Service (GPRS), high-speed downlink packet access (HSDPA), high-speed uplink packet access (HSUPA), newer version thereof, and/or replacements thereof. For WLAN communications, the baseband processing module 100 and the RF section 106 function in accordance with one or more wireless communication protocols such as, but not limited to, IEEE 802.11(a), (b), (g), (n), etc., Bluetooth, ZigBee, RFID, etc.

In another example of operation, the HH computing unit 12 communicates with the image capture module 50 via the coupling module 56 and 58 using MMW communications. In this state, the processing module 60, the baseband processing module 100 and the MMW section 104 are active. For example, the baseband processing module 100 receives an outbound signal from the control module 80 or from the processing module 60. The control module 80 may receive the outbound signal from the HH IO controller 86 or the HH main memory 82. The outbound signal may be a command for operation of the image capture module 50, the digital image file 74 for subsequent display, etc. The processing module 60 may receive the outbound signal from the control module 80 and further process the signal (e.g., combine it with another signal, generate a response, perform other than PHY layer processing, etc.) and provide the processed signal to the BB processing module 100 as the outbound signal.

The baseband processing module 100 converts an outbound signal into an outbound symbol stream in accordance with one or more existing wireless communication standards, new wireless communication standards, modifications thereof, and/or extensions thereof. The baseband processing module 100 may perform one or more of scrambling, encoding, constellation mapping, modulation, frequency spreading, frequency hopping, beamforming, space-time-block encoding, space-frequency-block encoding, and/or digital baseband to IF conversion to convert the outbound signal into the outbound symbol stream. Depending on the desired formatting of the outbound symbol stream, the baseband processing module 100 may generate the outbound symbol stream as Cartesian coordinates (e.g., having an in-phase signal component and a quadrature signal component to represent a symbol), as Polar coordinates (e.g., having a phase component and an amplitude component to represent a symbol), or as hybrid coordinates.

The MMW section 104 converts the outbound symbol stream into an outbound MMW signal in accordance with the one or more existing wireless communication standards, new wireless communication standards, modifications thereof, and/or extensions thereof. In one embodiment, the MMW section 104 receives the outbound symbol stream as Cartesian coordinates. In this embodiment, the MMW section 104 mixes the in-phase components of the outbound symbol stream with an in-phase local oscillation to produce a first mixed signal and mixes the quadrature components of the outbound symbol stream to produce a second mixed signal. The MMW section 104 combines the first and second mixed signals to produce an up-converted signal. The MMW section 104 then amplifies the up-converted signal to produce the outbound MMW signal, which it provides to an antenna structure 108. Note that further power amplification may occur between the output of the MMW section 104 and the input of the antenna structure 108.

In one or more other embodiments, the MMW section 104 receives the outbound symbol stream as Polar or hybrid coordinates. In these embodiments, the MMW section 104 modulates a local oscillator based on phase information of the outbound voice symbol stream to produce a phase modulated MMW signal. The MMW section 104 then amplifies the phase modulated MMW signal in accordance with amplitude information of the outbound symbol stream to produce the outbound MMW signal. Alternatively, the MMW section 104 may amplify the phase modulated MMW signal in accordance with a power level setting to produce the outbound MMW signal.

The MMW section 104 provides the outbound MMW signal to the antenna structure 108, which includes the plurality of inductors (L) and a plurality of antenna segments (T). For MMW signals, the antenna segments (T) function as independent antennas due to the impedance of the inductors (L) at the carrier frequency of the MMW signal (e.g., 60 GHz). As such, the MMW section 104 may provide the outbound MMW signal to one or more of the antenna segments (T) for MIMO communications, MISO communications, beamforming, etc.

For incoming MMW signals, the MMW section 104 receives an inbound MMW signal via the antenna section 108. The MMW section 104 converts the inbound MMW signal into an inbound symbol stream. In an embodiment, the MMW section 104 extracts Cartesian coordinates from the inbound MMW signal to produce the inbound symbol stream. In another embodiment, the MMW section 104 extracts Polar coordinates from the inbound MMW signal to produce the inbound symbol stream. In yet another embodiment, the MMW section 104 extracts hybrid coordinates from the inbound MMW signal to produce the inbound symbol stream.

The baseband processing module 100 converts the inbound symbol stream into an inbound signal. The baseband processing module 100 may perform one or more of descrambling, decoding, constellation demapping, modulation, frequency spreading decoding, frequency hopping decoding, beamforming decoding, space-time-block decoding, space-frequency-block decoding, and/or IF to digital baseband conversion to convert the inbound symbol stream into the inbound signal. Note that for MMW communications 114, the coupling module 56 includes a MMW transceiver that functions similarly to the MMW transceiver of the HH computing unit just described.

FIG. 7 is a schematic block diagram of another embodiment of the device that includes the handheld (HH) computing unit 12 and the image capture module 50. The image capture module 50 includes the user interface module 52 (not shown in this figure), the optical system module 54, the coupling module 56 (represented as a connection to the HH computing unit 12), the slave clock circuit 116, an analog to digital converter (ADC) 130, an autofocus module 132, and an electromechanical focus adjust module 134. The HH computing unit 12 includes the coupling module 58 (represented as a connection to the image capture module 50), the processing module 60, the memory 62, an output interface 144, and a display 146. While not shown, the image capture module 50 may further include a pop-up or fixed flash, a digital range finder, etc.

The optical system module 54 includes a light sensor array 124, a control module 126, an exposure control module 130, a timing module 130, and a fixed lens 120 or a lens mount 122 for coupling an interchangeable lens to the image capture module 50. The photoelectric light sensor array 124, which may be a charge coupled device (CCD), a CMOS sensor chip, a line scan image sensor, and/or other light sensing circuit, receives the light representing the image from the lens 120 directly or via the lens mount 122. The photoelectric light sensor array 124 generates the plurality of electric charges from the light in accordance with an exposure setting.

The control module 126, which may be part of the photoelectric light sensor array 124, generates the sequence of voltages from the plurality of electric charges. For example, if the photoelectric light sensor includes a one or two dimensional capacitor array, each capacitor to accumulate an electric charge proportional to the light intensity at that location. Once the array has been exposed to the image, the control module causes each capacitor to transfer its contents to its neighbor. The last capacitor in the array dumps its charge into a charge amplifier of the control module 126 to convert the charge into a voltage. The control module 126 repeats this to convert the contents of the array to a sequence of voltages.

The method of capturing an image may be done in a variety of ways. For example, the image may be captured in a single-shot method, a multi-shot method, or a scanning method. For the single shot method, the light sensor array 124 is exposed to the light once. Note that the optical system module 54 may include three sensor arrays 124 (one for each of the primary colors) and still use the single-shot method using a beam splitter. For the multi-shot method, the sensor array 124 is exposed to the light is a sequence of three or more lens aperture openings. For example, a single image sensor may be used with three filters (one for each primary color) to produce additive color information. The scanning method involves moving the sensor array moves across the focal plane.

The exposure control module 128 generates the exposure setting based on the exposure indication and provides it to the light sensor array 124 via the timing module 130. The exposure indication may be manually set or automatically set to control the amount of light that is allowed to be received by the sensor array 124. For manual setting of the exposure, the user adjusts the aperture and/or the shutter speed, which are sensed by the exposure control module 128 and provided to the sensor array 124 as the exposure setting.

For an automatic exposure setting, the exposure control module 128 interprets the sequence of voltages or the plurality of electric charges to determine the exposure setting (e.g., aperture setting and shutter speed). The determination may be based on a matching of the image's mid-tone to the mid-tone of the representation of the captured digital image (e.g., the voltages and/or the charges). To achieve this, the exposure control module 128 includes an exposure meter. The automatic determining of the exposure setting may be done just prior to the actual capturing of the image.

The ADC 130 converts the sequence of voltages into a stream of digital data, which it provides the to the HH computing unit 12. In an alternative embodiment, the ADC 130 may be within the HH computing unit 12 such that the HH computing unit receives the sequence of voltages or the representation thereof.

The autofocus sensor module 132 generates focus data regarding the image and the electromechanical focus adjust module 134 adjust focus of the optical system module 54 (e.g., adjusts the lens) based on the focus data. The autofocus sensor module 132 includes one or more sensors to determine the focus. The sensors may be through-the-lens optical autofocus sensor, which may also perform light metering.

As previously mentioned, the processing module 60 receives the representation of the sequence of voltages (e.g., a stream of digital data) and converts it into a digital image file. To do this, the processing module 60 includes the color processing module 136, the effects module 138, the encoding module 142, and the decoding module 140. The color processing module 136 generates a color image based on the representation of the sequence of voltages. For example, the color processing may be RGB (red-green-blue) color modeling.

The encoding module 142 encodes the color image in accordance with the file format protocol to produce the digital image file that is stored in memory 62. The format protocol may be Raw Data, JPEG, TIFF, etc.

Prior to encoding and subsequent storage, the color image may be further processes by the effects module 138. The effects module may perform mosaic filtering, interpolation, and/or anti-aliasing. In addition, the effects module 138 may process other functions such as red-eye color adjust, digital zoom, and/or any other manipulations of the digital image as requested by the user to produce an adjusted color image. The adjusted color image is then encoded and stored in memory.

The stored digital image file may be retrieved from memory 62, decoded by decoding module 140, and provided to the output interface 144 for subsequent display on the display 146. The display may be an LCD display, back-light display, or other compact display. To provide the display with properly formatted data, the output interface converts the decoded image file into display data, which may be one or more of analog signals, digital signals, RGB data, composite video, component video, S-video, etc.

In addition to displaying the stored image file, the display 146 may function as a live preview display. In this instance, the color processing module 136 provides the color image or adjusted color image to the decoding module 140. The decoding module 140 passes the color image or the adjusted color image to the output interface 144, which processes it to produce display data.

FIG. 8 is a schematic block diagram of another embodiment of a device that includes the handheld computing unit 12 and the image capture module 50. This embodiment is similar to that of FIG. 7, with the exception that the output interface 148 and the display 150 are part of the image capture module 50. In this embodiment, the processing module 60 functions as discussed with reference to FIG. 7 but provides the image data for display to the output interface 148 via a wired or wireless coupling modules 56 and 58.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A device comprises:
an image capture module that includes:
user interface module operably coupled to:
detect a request to capture an image; and
generate a capture command signal in response to detecting the request;
an optical system module operably coupled to:
receive light representing the image from a lens in accordance with the capture command signal;
accumulate a plurality of electric charges, wherein an electric charge of the plurality of electric charges is proportional to intensity of a corresponding portion of the light; and
generate a sequence of voltages from the plurality of electric charges;
a first coupling module operably coupled to:
convert a representation of the sequence of voltages into a transmission signal; and
transmit the transmission signal;
a handheld computing unit that includes:
a second coupling module operably coupled to:
receive the transmission signal; and
recover the representation of the sequence of voltages from the transmission signal;
a processing module operably coupled to convert the representation of the sequence of voltages into a digital image file in accordance with a file format protocol; and
memory operably coupled to store the digital image file.

2. The device of claim 1, wherein the optical system comprises:
a photoelectric light sensor array operably coupled to:
receive the light representing the image from the lens; and
generate the plurality of electric charges from the light in accordance with an exposure setting;
a control module operably coupled to generate the sequence of voltages from the plurality of electric charges; and
exposure control module operably coupled to generate the exposure setting based on the exposure indication, wherein the exposure indication is based on the sequence of voltages or the plurality of electric charges.

3. The device of claim 1, wherein the image capture module further comprises:
a lens mount for coupling the lens to the optical system; or
a fixed lens that provides, as the lens, the light representing the image to the optical system module.

4. The device of claim 1, wherein the image capture module further comprises:
an analog to digital conversion module coupled to convert the sequence of voltages from an analog domain to a digital domain to produce the representation of the sequence of voltages.

5. The device of claim 1, wherein the image capture module further comprises:
an autofocus sensor module operably coupled to generate focus data regarding the image; and
an electromechanical focus adjust module operably coupled to adjust focus of the optical system based on the focus data.

6. The device of claim 1, wherein the processing module converts the representation of the sequence of voltages into the digital image file by:
generating a color image based on the representation of the sequence of voltages; and
encoding the color image in accordance with the file format protocol to produce the digital image file.

7. The device of claim 1, wherein the converting the representation of the sequence of voltages into the digital image by the processing module further comprises:
generating a color image based on the representation of the sequence of voltages;
adjusting effects of the color image to produce an adjusted color image; and
encoding the adjusted color image in accordance with the file format protocol to produce the digital image file.

8. The device of claim 1, wherein the handheld computing unit further comprises:
decoding module operably coupled to decode the digital image file to produce a decoded image file; and
an output interface operably coupled to convert the decoded image file into display data.

9. The device of claim 1 further comprises:
the handheld computing unit further including a decoding module operably coupled to decode the digital image file to produce a decoded image file;
the second coupling module operably coupled to:
convert the decoded image file into a second transmission signal; and
transmit the second transmission signal;
the first coupling module operably coupled to:
receive the second transmission signal; and
recover the decoded image file from the second transmission signal; and
the image capture module further includes an output interface operably coupled to convert the decoded image file into display data.

10. The device of claim 1 further comprises:
the first coupling module operably coupled to:
convert the representation of the sequence of voltages into the transmission signal in accordance with a wired transmission protocol; and
transmit the transmission signal via a wired communication path;
the second coupling module operably coupled to:
receive the transmission signal via the wired communication path; and
recover the representation of the sequence of voltages from the transmission signal in accordance with the wired transmission protocol.

11. The device of claim 1 further comprises:
the first coupling module operably coupled to:
convert the representation of the sequence of voltages into the transmission signal in accordance with a wireless transmission protocol; and
transmit the transmission signal via a wireless communication path;
the second coupling module operably coupled to:
receive the transmission signal via the wireless communication path; and
recover the representation of the sequence of voltages from the transmission signal in accordance with the wireless transmission protocol.

12. An image capture module comprises:
user interface module operably coupled to:
detect a request to capture an image; and
generate a capture command signal in response to detecting the request;
an optical system module operably coupled to:
receive light representing the image from a lens in accordance with the capture command signal;
accumulate a plurality of electric charges, wherein an electric charge of the plurality of electric charges is proportional to intensity of a corresponding portion of the light; and
generate a sequence of voltages from the plurality of electric charges; and
a coupling module operably coupled to:
convert a representation of the sequence of voltages into a transmission signal; and
transmit the transmission signal.

13. The image capture module of claim 12, wherein the optical system comprises:
a photoelectric light sensor array operably coupled to:
receive the light representing the image from the lens; and
generate the plurality of electric charges from the light in accordance with an exposure setting;
a control module operably coupled to generate the sequence of voltages from the plurality of electric charges; and
exposure control module operably coupled to generate the exposure setting based on the exposure indication, wherein the exposure indication is based on the sequence of voltages or the plurality of electric charges.

14. The image capture module of claim 12 further comprises:
a lens mount for coupling the lens to the optical system; or
a fixed lens that provides, as the lens, the light representing the image to the optical system module.

15. The image capture module of claim 12 further comprises:
an analog to digital conversion module coupled to convert the sequence of voltages from an analog domain to a digital domain to produce the representation of the sequence of voltages.

16. The image capture module of claim 12 further comprises:
an autofocus sensor module operably coupled to generate focus data regarding the image; and
an electromechanical focus adjust module operably coupled to adjust focus of the optical system based on the focus data.

17. The image capture module of claim 12 further comprises:
the coupling module operably coupled to:
receive a second transmission signal; and
recover a decoded image file from the second transmission signal; and
an output interface operably coupled to convert the decoded image file into display data.

18. The image capture module of claim 12 further comprises:
the coupling module operably coupled to:
convert the representation of the sequence of voltages into the transmission signal in accordance with a wired transmission protocol; and
transmit the transmission signal via a wired communication path; or
the first coupling module operably coupled to:
convert the representation of the sequence of voltages into the transmission signal in accordance with a wireless transmission protocol; and
transmit the transmission signal via a wireless communication path.

19. An integrated circuit (IC) comprises:
an optical system module operably coupled to:
receiving light representing the image from a lens in accordance with the capture command signal;
accumulating a plurality of electric charges, wherein an electric charge of the plurality of electric charges is proportional to intensity of a corresponding portion of the light; and
generating a sequence of voltages from the plurality of electric charges; and
a coupling module operably coupled to:
convert a representation of the sequence of voltages into a transmission signal; and
transmit the transmission signal.

20. The IC of claim 19, wherein the optical system comprises:
a photoelectric light sensor array operably coupled to:
receive the light representing the image from the lens; and
generate the plurality of electric charges from the light in accordance with an exposure setting;
a control module operably coupled to generate the sequence of voltages from the plurality of electric charges; and
exposure control module operably coupled to generate the exposure setting based on the exposure indication, wherein the exposure indication is based on the sequence of voltages or the plurality of electric charges.

21. The IC of claim 19 further comprises:
an analog to digital conversion module coupled to convert the sequence of voltages from an analog domain to a digital domain to produce the representation of the sequence of voltages.

22. The IC of claim 19 further comprises:
an autofocus sensor module operably coupled to generate focus data regarding the image; and
an electromechanical focus adjust module operably coupled to adjust focus of the optical system based on the focus data.

23. The IC of claim 19 further comprises:
the coupling module operably coupled to:
receive a second transmission signal; and
recover a decoded image file from the second transmission signal; and
an output interface operably coupled to convert the decoded image file into display data.

24. The IC of claim 19 further comprises:
the coupling module operably coupled to:
convert the representation of the sequence of voltages into the transmission signal in accordance with a wired transmission protocol; and
transmit the transmission signal via a wired communication path; or
the first coupling module operably coupled to:
convert the representation of the sequence of voltages into the transmission signal in accordance with a wireless transmission protocol; and
transmit the transmission signal via a wireless communication path.
